(19) United States
(12) Patent Application Publication
(10) Pub. No.: US 2014/0293584 A1
(43) Pub. Date: Oct. 2, 2014

(54) DISPLAY DEVICE AND IMAGE FORMING APPARATUS

(71) Applicant: KYOCERA Document Solutions Inc., Osaka (JP)

(72) Inventor: Naoki SHIBATA, Osaka (JP)

(73) Assignee: KYOCERA Document Solutions Inc., Osaka (JP)

(21) Appl. No.: 14/227,431

(22) Filed: Mar. 27, 2014

(30) Foreign Application Priority Data
Mar. 28, 2013 (JP) 2013-068834

(51) Int. Cl. F21V 11/00

(52) U.S. Cl. CPC F21V 11/00
USPC 362/97.4

(57) ABSTRACT

A display device includes a light source and a light-transmissive display plate. The display plate is disposed at the light-emitting side of the light source. The display plate has an inner surface facing toward the light source and an outer surface facing away from the inner surface. The inner surface and the outer surface of the display plate each have a grain finish. The grain finish on the outer surface is finer in grain roughness than the grain finish on the inner surface.

### INCORPORATION BY REFERENCE

The present application claims priority under 35 U.S.C. §119 to Japanese Patent Application No. 2013-068834, filed Mar. 28, 2013. The contents of this application are incorporated herein by reference in their entirety.

### BACKGROUND

The present disclosure relates to display devices for displaying, for example, numerals, and also relates to image forming apparatuses that include such a display device.

Some image forming apparatuses (copiers, for example) for forming images on paper by an electrographic method are provided with a display device that is for displaying numerals (to indicate the number of copies or an error code, for example). Some display devices employ, as a light source, a light-emitting diode (LED) having a high luminous efficiency and a long life. However, the light distribution of an LED exhibits high directivity. Therefore, the use of an LED as the light source of a display device often results in that the amount of light is higher at the center of the display plate and increasingly lower with a distance from the center. For this reason, display devices that include an LED are likely to suffer from a problem of being more prone to non-uniform brightness across the display plate.

One suggestion made in view of the above is to provide a display device with a diffusion sheet 108 between a light source 102 and a display plate 105 (hereinafter, referred to as a first display device) as shown in FIG. 4. The first display device includes the light source 102, the display plate 105 having a light-transmitting property and disposed at the light-emitting side of the light source 102, and the diffusion sheet 108 disposed between the light source 102 and the display plate 105. The first display device reduces the non-uniformity in brightness by the diffusion sheet 108 diffusing the highly directive light emitted from the light source 102.

Another suggestion is made to provide a display device with a light-transmissive display plate, a light source disposed at a position lateral to the display plate, a reflector plate disposed between the display plate and the light source, a first diffusion sheet disposed between the display plate and the reflector plate, and a second diffusion sheet disposed between the reflector plate and the light source (hereinafter, referred to as a second display device). The reflector plate reflects light emitted from the light source toward the rear surface of the display plate. The first diffusion sheet diffuses light reflected by the reflector plate toward the rear surface of the display plate. The second diffusion sheet diffuses light emitted from the light source toward the reflector plate. In the second display device, a spot of light emitted by the light source is diffused by the diffusion action of the second diffusion sheet and then reflected by the reflector plate. In addition, light reflected by the reflector plate (reflected diffused light) enters the first diffusion sheet to be further diffused to illuminate the rear surface of the display plate. This arrangement ensures the display plate to have a uniform illuminance distribution.

### SUMMARY

A display device according to the present disclosure includes a light source and a light-transmissive display plate. The display plate is disposed at a light-emitting side of the light source. The display plate has an inner surface facing toward the light source and an outer surface facing away from the inner surface. The inner surface and the outer surface of the display plate each have a grain finish. The grain finish on the outer surface is finer in grain roughness than the grain finish on the inner surface.

An image forming apparatus according to the present disclosure includes a display device according to the present disclosure.

### BRIEF DESCRIPTION OF THE DRAWINGS

FIG. 1 is a perspective view showing an upper portion of an image forming apparatus according to an embodiment of the present disclosure.

FIG. 2 is an exploded perspective view of a display device according to the embodiment of the present disclosure.

FIG. 3 is a sectional view of the display device according to the embodiment of the present disclosure.

FIG. 4 is a sectional view showing one example of a display device.

### DETAILED DESCRIPTION

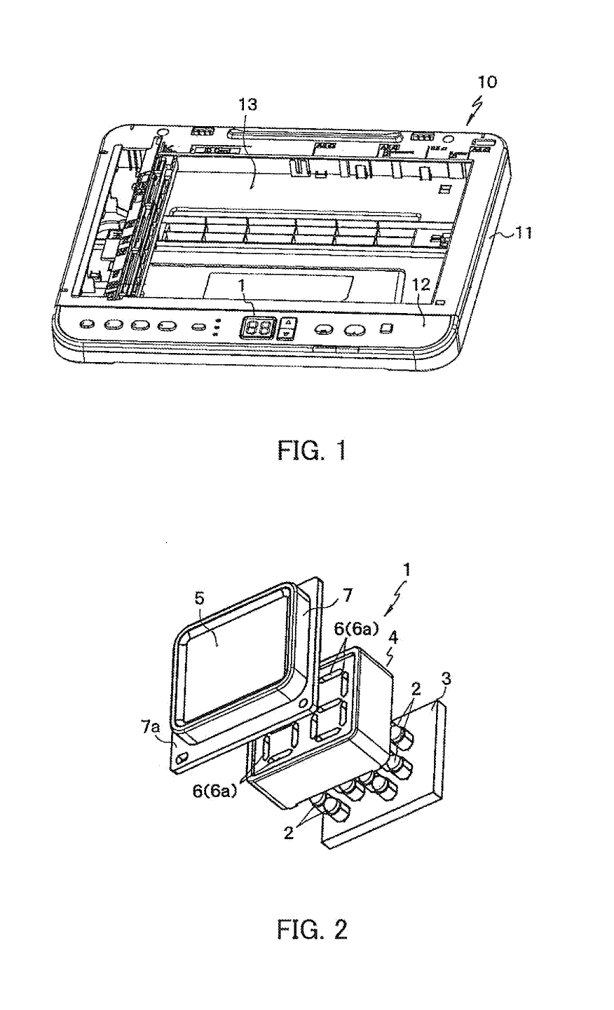

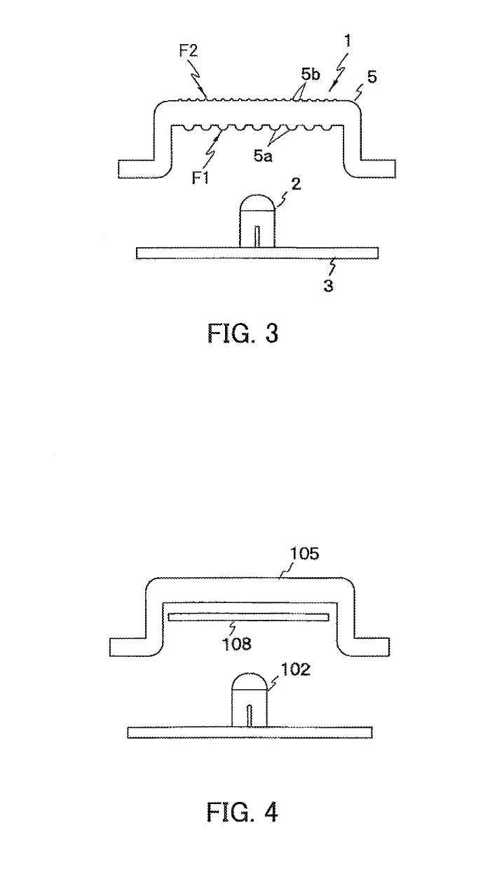

The following describes an embodiment of the present disclosure with reference to the accompanying drawings. FIG. 1 is a perspective view showing an upper portion an image forming apparatus (copier 10) according to the present embodiment. FIG. 2 is an exploded perspective view of a display device 1 according to the present embodiment. FIG. 3 is a sectional view of the display device 1 according to the present embodiment.

The image forming apparatus according to the present embodiment is the copier 10 as shown in FIG. 1. The copier 10 includes an image reading section 11 and an operating section 12. The image reading section 11 is disposed at the topmost portion of the copier 10. On the top face of the image reading section 11, a platen glass 13 is disposed that is a transparent rectangular flat plate. The image reading section 11 is a device for optically reading an image of a document (not shown) placed on the platen glass 13.

The operating section 12 is disposed at the edge portion of the copier 10 (for example, at a location forward of the image reading section 11 in FIG. 1). The operating section 12 has a laterally elongated shape, for example. The operating section 12 extends across the substantially entire width of the copier 10, for example.

The operating section 12 includes the display device 1. The display device 1 is disposed at the widthwise center of the operating section 12, for example. The display device 1 displays, for example, a two-digit numeral (indicating the number of copies or an error code, for example). Note that the object to be displayed on the display device 1 is not limited to a two-digit numeral and can be appropriately selected.

As shown in FIG. 2, the display device 1 includes a substrate 3, a display section 4 (segment frame) disposed above the substrate 3, and a display plate 5 covering the display section 4 from above. The substrate 3 has the shape of a flat rectangular plate, for example. The display section 4 has the shape of a rectangular block, for example. The display plate 5 has the shape of a flat rectangular plate, for example. A plurality of (fourteen, in the present embodiment) LEDs 2 are mounted on the substrate 3. In the present embodiment, the LEDs 2 serve as a light source. However, the light source is not limited to an LED and may be appropriately selected.

The display section 4 has seven segments 6 (hereinafter, collectively referred to as a segment group) arranged to form the shape of the numeral “8”. The segment group is composed of two adjoining squares each side of which is constituted by one of the segments 6. The two squares share the side at the boundary between them, so that the shared side is part of both the squares. The display section 4 includes a plurality of (two, in the present embodiment) segment groups.

Each segment 6 has a light-transmitting property. According to the present embodiment, each segment 6 is an elongated opening (slit) 6a formed in the display section (segment frame) 4. Alternatively, each segment 6 may be made from a light-transmissive material (for example, a transparent or semi-transparent resin).

Below each segment 6, one LED 2 is provided. In the present embodiment, one light source (LED 2) is provided for one segment 6. That is, the total number of the LEDs 2 disposed below the two segment groups is fourteen. Each LED 2 is disposed substantially below the center of the corresponding segment 6 (corresponding opening 6a). Partition walls (not shown) are formed below each segment 6 (opening 6a) to surround the corresponding LED 2.

Light emitted by each LED 2 passes through the corresponding segment 6 (opening 6a) to the outside. By controlling ON and OFF of the fourteen LEDs 2, the respective segment groups can each represent all numerals from “0” to “9”.

The display plate 5 is made from a light-transmissive material (for example, a transparent or semi-transparent resin). The display plate 5 is integrally provided with a frame 7 having a shape of a rectangular frame. The frame 7 is integrally provided with a mounting flange 7a along its periphery.

FIG. 3 schematically shows a configuration of the display device 1 according to the present disclosure. In FIG. 3, the display section 4 is omitted to exclusively show one LED 2 (out of the plurality of LEDs 2), the substrate 3, and the display plate 5.

The display plate 5 is disposed at the light-emitting side of the LED 2. The display plate 5 has an inner surface F1 (the surface facing toward the light source) and an outer surface F2 (the surface facing away from the light source). According to the present embodiment, the inner surface F1 and the outer surface F2 are parallel to each other. Each segment 6 (opening 6a) confronts the inner surface F1 of the display plate 5. The LED 2, the display section 4, and the display plate 5 are disposed so as to allow light emitted from the LED 2 to pass through the corresponding one of the 14 segments 6 (openings 6a) to illuminate the inner surface F1 of the display plate 5.

The inner surface F1 and the outer surface F2 of the display plate 5 each have a grain finish. The grain finish on the outer surface F2 is finer in grain roughness than the grain finish on the inner surface F1. Grains 5a on the inner surface F1 of the display plate 5 may be, for example, TH141A by Tanazawa Hakkosha Co., Ltd. (the arithmetic mean roughness Ra is about 1.95 μm), and grains 5b on the outer surface F2 of the display plate 5 may be, for example, TH128 by Tanazawa Hakkosha Co., Ltd. (the arithmetic mean roughness Ra is about 0.17 μm). In the display device 1 according to the embodiment, the LEDs 2 emit light upon application of electric current. The highly directive light emitted from the LEDs 2 is diffused by the rough grains 5a formed on the inner surface F1 of the display plate 5.

Provided that the outer surface F2 of the display plate 5 has no grains formed thereon, light diffused by the rough grains 5a is assumed to form an image with non-uniform brightness (with a granular appearance). In contrast, the display device 1 according to the present embodiment includes the display plate 5 having the outer surface F2 provided with the fine grains 5b formed thereon. This ensures that the light diffused by the rough grains 5a is further diffused by the fine grains 5b, which leads to elimination of the non-uniformity in brightness (granular appearance). As a result, the display plate 5 is promoted to have a uniform illuminance distribution.

As has been described above, the display device 1 according to the present embodiment has the LEDs 2 (light sources) and the display plate 5 having light-transmitting property. The display plate 5 is disposed at the light-emitting side of the LED 2. In addition, the display plate 5 has the inner surface F1 facing toward the LEDs 2 (light sources) and the outer surface F2 facing away from the inner surface Fl. The inner surface F1 and the outer surface F2 of the display plate 5 each have a grain finish. The grain finish on the outer surface F2 is finer in grain roughness than the grain finish on the inner surface F1. With the configuration in which the display plate 5 is provided with a grain finish, the display plate 5 is promoted to have a uniform illuminance distribution, without requiring a reflector plate or sheet to be additionally provided. This is effective to reduce the number of parts and the number of man-hours required for assembling (and thus to reduce the manufacturing cost of the display device 1). Further, the two parallel diffusion surfaces (the inner surface F1 and the outer surface F2) can be formed relatively easily. Still further, the loss of light in the display device 1 can be reduced. As a consequence, the energy efficiency of the display device 1 improves.

Note that the configuration stated above is applicable to any display device. For example, the above configuration is applicable to a display device included in an image forming apparatus other than a copier (for example, in a scanner, a printer, a facsimile machine, or a multi-function peripheral).

What is claimed is:

1. A display device, comprising:
at least one light source; and
a light-transmissive display plate, wherein
the display plate is disposed at a light-emitting side of the at least one light source, and has an inner surface facing toward the light source and an outer surface facing away from the light source,
the inner surface and the outer surface each have a grain finish, and
the grain finish on the outer surface is finer in grain roughness than the grain finish on the inner surface.

2. A display device according to claim 1, further comprising
a segment frame including a plurality of segments, wherein
the at least one light source, the segment frame, and the display plate are disposed so as to allow light emitted from the light source to pass through the respective segments to illuminate the inner surface of the display plate.

3. A display device according to claim 2, wherein
each of the plurality of segments is an opening formed in the segment frame.

4. A display device according to claim 2, wherein
the at least one light source comprises a plurality of light sources one for each of the segment.

5. A display device according to claim 2, wherein
each of the plurality of segments confronts the inner surface of the display plate.

6. A display device according to claim 2, wherein
the plurality of segments forms a segment group capable of representing all numerals from 0 to 9.

7. A display device according to claim 6, wherein
the number of the segments forming the segment group is seven.

8. An image forming apparatus comprising
a display device according to claim 1.
